(19) United States
(12) Patent Application Publication
(10) Pub. No.: US 2004/0176135 A1
(43) Pub. Date: Sep. 9, 2004

(54) Method, system and interworking unit for combining the signalling link of the two different control planes in a distributed radio access network

(76) Inventor: Virpi Palkisto, Espoo (FI)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/737,818

(22) Filed: Dec. 18, 2003

Related U.S. Application Data
(60) Provisional application No. 60/440,048, filed on Jan. 15, 2003.

(51) Int. Cl. H04M 1/00; H04B 1/38

(52) U.S. Cl. 455/560; 455/422.1

(57) ABSTRACT

A method, system and interworking unit for implementing a combined signalling link for CS and PS side signalling in lu′ interface. The invention provides an interworking unit between a base station and core network so as to facilitate the signalling of control planes to decrease excess signalling. The invention implements a combined signalling link for both lu′-CS Control Plane and lu′-PS Control plane signalling. In this context the distributed radio access network is based on IP (Internet Protocol).

The present application claims the benefit of priority of Provisional Application Serial No. 60/440,048, filed Jan. 15, 2003, the contents of which are incorporated herein by reference.

### FIELD OF THE INVENTION

The present invention relates to the telecommunication systems. In particular, the present invention relates to a novel and improved method, system and interworking unit for combining the signalling link of the two different control planes related to a certain user equipment (UE) and different core network (CN) domains in a distributed radio access network.

### BACKGROUND OF THE INVENTION

In the current specifications of the third generation mobile networks (referred to as UMTS, Universal Mobile Telecommunication Systems) the system utilises the same well-known architecture scheme that has been used by all main second generation systems. A block diagram of the system architecture of current UMTS network with some modifications for IP (Internet Protocol) functionalities in access network is presented in FIG. 1. The UMTS network architecture includes the core network (CN), the radio access network (RAN), and the user equipment (UE) or mobile station (MS). The radio access network can also be GERAN (GSM/EDGE radio access network) that is an enhanced GSM radio access network. work. Enhanced here means that GERAN uses EDGE as a radio technology. EDGE allows the usage of 3G services with 800/900/ 1800/1900 MHz frequency bands. GERAN offers full advantages of GPRS (General Packet Radio System) to be explored. The core network is further connected to the external networks, i.e. Internet, or telephone networks like PLMN, PSTN and/or ISDN. The distributed RAN architecture consists of several radio network access servers (RNAS) and several base stations (BTS, referred to as B+ nodes in this document). In FIG. 1 only one example of each component is presented.

In this architecture there are several different connections between the network elements. To mention the most essential, the lu interface connects CN to RAN and lu′ interface connects an RNAS and a nodeB+.

An IP RAN (Internet Protocol Radio Access Network) is a RAN architecture that is fully optimised to carry IP traffic. IP RAN is an example of an implementation of distributed RAN. In this configuration the division of functionalities between network elements is fundamentally re-defined to suit the needs of IP traffic. This is clearly different from just using IP as a transport solution with the existing network architectures like GSM (Global System for Mobile Communications) and CDMA (Code Division Multiple Access) based radio access networks.

In order to obtain the most efficient RAN architecture, some functionality has to be relocated between network elements. In the most revolutionary architecture we no longer have a network element commonly known as a BSC (Base Station Controller) or RNC (Radio Network Controller), although this functionality must remain in the RAN.

RANAP (Radio Access Network Application Part) provides the signalling service between RAN and CN to enable the below mentioned functions of RANAP. These services are divided into three groups. (1) General control services: They are related to the whole lu interface instance between RNC and logical CN domain (PS, Packet Switched or CS, Circuit Switched), and are accessed in CN through the General Control SAP (Service Access Point). They utilise connectionless signalling transport provided by the lu signalling bearer. (2) Notification services: They are related to specified UEs or all UEs in specified area, and are accessed in CN through the Notification SAP. They utilise connectionless signalling transport provided by the lu signalling bearer. (3) Dedicated control services: They are related to one UE, and are accessed in CN through the Dedicated Control SAP.

RANAP functions that provide above mentioned services are associated with lu signalling connection that is maintained for the UE in question. The lu signalling connection is realised with connection oriented signalling transport provided by the lu signalling bearer. RANAP protocol has, among other things, the following functions:

Relocating UE. This function enables to change the functionality of radio control as well as the related lu resources (RAB(s) and Signalling connection) from one RNC (In lu′, nodeB+) to another.

Overall RAB (Radio Access Bearer) management. This function is responsible for setting up, modifying and releasing RABs.

Release of all lu and lu′ connections resources. This function is used to explicitly release all resources related to one lu and lu′ connections.

Requesting the release of all lu and lu′ connection re sources. While the lu and lu′ release is managed from the CN, the radio controller has the capability to request the release of all lu and lu′ connection resources from the corresponding lu and lu′ connection.

Paging the user. This function provides the CN for capability to page the UE.

CS and PS CN are specified as separate network elements, i.e., MSC (Mobile Switching Centre) and SGSN (Serving GPRS Support Node), correspondingly. Due to this, both of them require an own interface towards radio access network. RANAP contains separate definitions needed for both domains (CS and PS). Furthermore, relocation procedures are performed separately towards both domains. When UE has an active call in CS domain and an active data connection in PS domain, it has active lu signalling links towards both domains (CS and PS). In the above described distributed radio access network architecture this also means that RNAS has separate lu′ signalling links (CS and PS) towards nodeB+.

To sum up, in a distributed RAN architecture lu interface is implemented to two levels, i.e. between RNAS and CN (lu Interface), and between RNAS and nodeB+(lu′ interface) as is disclosed in FIG. 1. Because lu interface is used as a basis for lu′ interface, UE having active CS and PS connections, has two lu′ signalling links between nodeB+ and RNAS, and inter nodeB+ relocation procedures are performed separately using those links also in lu′ level. This causes double signalling between RNAS and Node B+. lu′ and lu signalling links are established to RNAS when UE performs initial access or UE is relocated to distributed RAN. One of the functions of RNAS is to store UE's CS and PS RAB information, IMSI (International Mobile Subscriber Identity) and nodeB+ identifier to its database. CS and PS side signalling is performed independently of each other.

### SUMMARY OF THE INVENTION

Consequently, the present invention concerns a novel and improved method and system for implementing a combined signalling link for CS and PUG side signalling in lu′ interface. The object of these are to substantially obviate one or more of the above mentioned limitations and disadvantages of the related art.

Furthermore, an objective of the present invention is to provide an interworking unit between the base station and core network, and to facilitate the signalling of control planes to decrease excess signalling.

This is achieved by means of a method for implementing a combined signalling link for both lu′-CS Control Plane and lu′-PS Control plane signalling. In distributed RAN, the functionalities of the radio control elements, e.g. RNC or BSC are implemented in the base stations. Logically this kind of structure can be seen as a partial radio access network (RAN) even if the certain functionalities may have been preserved outside the base stations.

The invention discloses a method for implementing a control plane signalling instance for at least two user plane instances, of which at least one is CS and at least one is PS and both are related to the same UE, in a distributed radio access network. According to the present invention there is created a first interface instance including said user plane instances and one signalling link for said control plane signalling of said user plane instances between an interworking unit and a core network. The method further comprises the steps of creating a common interface instance including one signalling link between said interworking unit and a base station for control plane signalling of said user plane instances and directing all control plane signalling of said user planes via said common interface instance.

According to another aspect, the invention relates to a system for implementing a control plane signalling instance for at least two user plane instances, of which at least one is CS and at least one is PS and both are related to the same UE, in a distributed radio access network. The system includes a first interface instance comprising at least two user plane instances and two signalling connections for said control plane signalling of said user plane instances between an interworking unit, a core network, and a base station.

According to the present invention the system further comprises an interworking unit for connecting said core network to said base station, said interworking unit comprising a common interface instance consisting of one signalling link between said interworking unit and a base station for control plane signalling of said user plane instances, wherein all control plane signalling of said user planes is directed via said common interface instance.

According to one embodiment of the present invention, a mobile station has only one lu′ signaling link and one or two lu signaling links. A new lu′ signalling link is created only when mobile station performs initial access with a new RRC (Radio Resource Control) connection or when mobile station is relocated to another nodeB+ via access server or Interworking Unit. Said lu′ signalling link is released when there are no RABs and activity for the mobile station. Also In RAB lists indicating the active or idle radio access bearers, CN domain indicator is associated to each RAB id to make RAB ids of each mobile station unambiguous.

According to another aspect, the invention relates to an interworking unit for implementing a control plane signalling instance in a radio access network connected to at least two core network domains, wherein said interworking unit connects a core network to a base station. The interworking unit further comprises a first interface instance comprising at least one signalling link for said control plane signalling between an interworking unit and said core network related to one mobile station, a common interface instance including one signalling link between said interworking unit and said base station for control plane signalling, wherein all control plane signalling related to different core network domains is directed via said common interface instance.

Thanks to the present invention, for mobile stations having simultaneous CS and PS connections there is less lu′ signaling links, less external control signaling in relocations (8 RANAP′ messages and lu′ connection establishment and release if separate links and combined relocations are used), less processing, as there are many things done once instead of twice (target nodeB+, analysis of relocation type, interpreting containers etc). Also there is no need for coordination of relocation messages in inter nodeB+ relocations in nodeB+.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 is a block diagram illustrating an example of the state of the art scenario relating to the present mobile network;

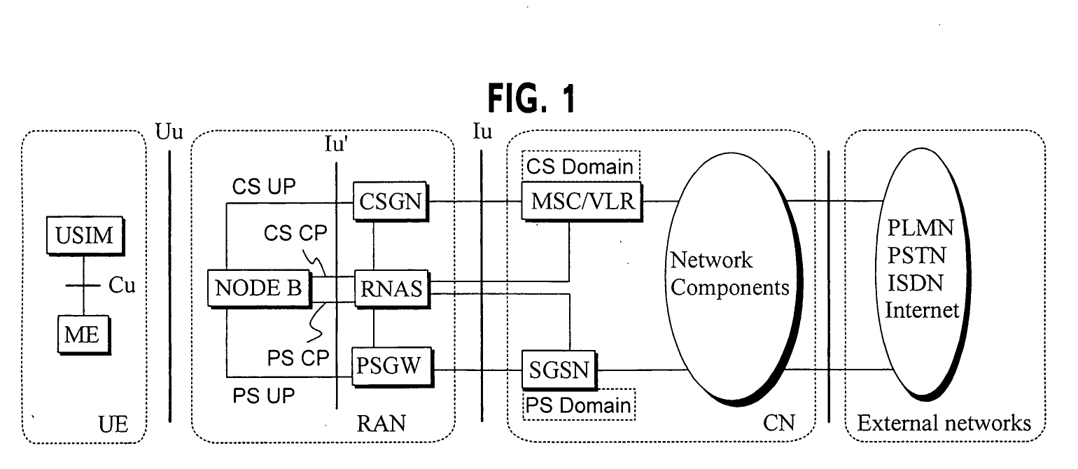

FIG. 2 is block diagram describing an example of radio access network according to one embodiment of the present invention;

FIG. 3 is a signalling diagram of one embodiment according to the present invention; and

FIG. 4 discloses a signalling diagram for one embodiment of the present invention.

### DETAILED DESCRIPTION OF THE INVENTION

Reference will now be made in detail to the embodiments of the present invention, examples of which are illustrated in the accompanying drawings.

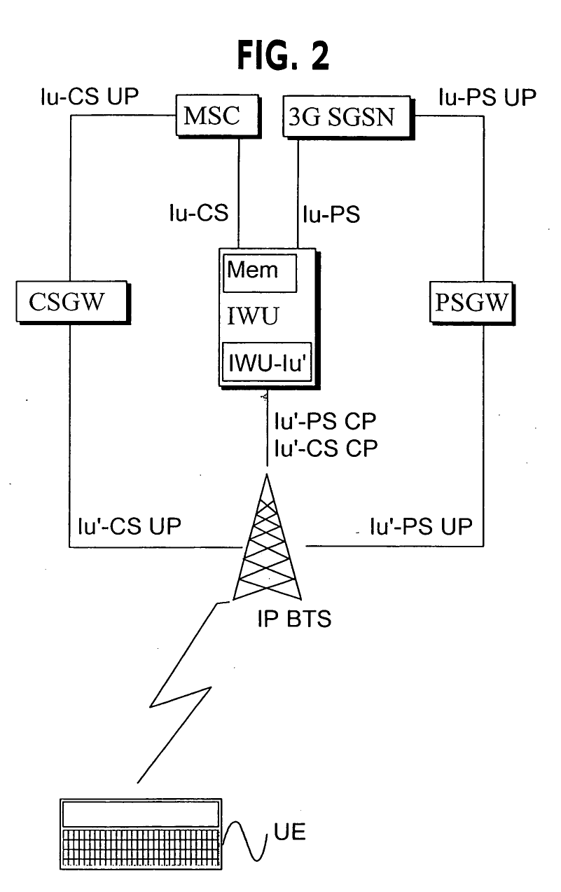

In FIG. 2 is described one embodiment of the present invention. FIG. 2 discloses a system for implementing a control plane signalling instance for at least two user plane instances (CS, PS) in a distributed radio access network.

Said system includes a first interface instance lu-CS, lu-PS comprising at least two user plane instances lu-PS UP, lu-CS UP and two signalling connections lu-PS CP, lu-CS CP for said control plane signalling of said user plane instances between an interworking unit IWU and a core network CN. Said system further includes an interworking unit IWU for connecting said core network CN to a base station nodeB+. The interworking unit further comprises a common interface instance lu′ consisting of one signalling link between said interworking unit IWU and a base station nodeB+ for control plane signalling of said user plane instances. In the system of FIG. 2 all control plane signalling of said user planes is directed via said common interface instance lu′ in the manner described below.

Furthermore, in FIG. 2 the interworking unit IWU can be implemented in a radio access network server (not shown). Said interworking unit IWU further comprises an interface IWU-lu′ for a common interface instance lu′. This common interface instance lu′ is released whenever there is no radio access bearer is RAB and activity for a mobile station UE. In one embodiment said interworking unit comprises memory MEM for storing a CN domain indicator in said interworking unit IWU.

CS (Circuit Switched) Gateway CSGW is a logical element used for the interworking of distributed RAN at least towards lu-CS interface. PS Gateway PSGW is the IP user plane access point from the core network CN to distributed radio access network RAN. During the Radio Access Bearer assignment procedure, RAN returns to the CN transport address(es) owned by the PSGW, where the user plane shall be terminated. Interworking unit IWU or RAN Access Server RNAS acts as a signalling gateway between RAN and CN. It has the following functions. It discriminates lu control plane messages and relays them further. It also can have paging server functions, i.e. RNAS keeps track of the UE RRC (Radio Resource Control) status and location, processes the idle mode paging messages and other connectionless messages from the core network CN, and forwards them to the nodeB+ controlling the cell the message is targeted to. IWU is also a Micromobility control point, i.e. it selects and controls the gateways PSGW, CSGW, also during the relocation of the nodeB+.

In more detail, the IWU has the following functions: RANAP (RAN Application Part) connection termination, setup and release of the signalling connections, discrimination of connectionless messages, processing of RANAP connectionless protocol messages; in User plane control: selection of the PSGW /CSGW unit, initialisation and control of the CSGW/PSGW entity for the mobile station UE connections, also during nodeB+ relocation, Control plane anchor (function required only if UCF (UE Control Function) is not included in the IWU), redirection of the signalling connection in case of UCF Relocation; in paging: Storing of ‘common ID’ information for the existing radio resource control (RRC) connection, Relaying of idle mode paging message to the relevant entities, Reset and overload control, Management of Reset and overload messages to/from the CN; and in PSGW/CSGW Management: Management of the logical resources of the PSGW/CSGW (addresses, etc.) etc.

In the light of the present invention the above listed functions of radio network access server RNAS or interworking unit IWU have to be modified at least in following ways. Interworking unit IWU here is intended as a signalling interworking unit for control plane processing and address translation. The interworking unit IWU can also be referred to as Radio Network Access Server RNAS. However it should be noted that RNAS in distributed RAN has more functions, as described above, than the signalling interworking.

Relating to the establishment and release of lu(′) links the present database contents requirements are still applicable. The only difference is, that there can be one lu′ instance per mobile station or user UE instead of two. If mobile station UE performs initial access to both CS and PS sides to the same IWU, both CS and PS RAB information are located in the same IWU.

Interworking unit IWU must be prepared to receive RANAP′ Initial UE without lu′ signalling connection establishment. RANAP′ lu release-message does not necessarily mean the release of lu′ link. However, CN domain indicator is needed, which may have three values (CS/PS/both) For each incoming connection oriented lu message, interworking unit IWU has to associate lu signaling link identifier to lu′ signaling link identifier. CN domain indicator is added to the corresponding RANAP′ message. Then the message is forwarded to nodeB+ using the selected lu′ signaling link. For each incoming connection oriented lu′ message, interworking unit IWU has to associate lu′ signaling link identifier to lu signaling link identifier and remove CN domain indicator from the message. Then the message can be forwarded to the CN using the selected/corresponding lu signaling link.

In external relocations, interworking unit IWU must be able to coordinate and combine relocation related RANAP messages to RANAP′ messages and vice versa. IWU must be able to build and interpret combined RANAP′ relocation messages.

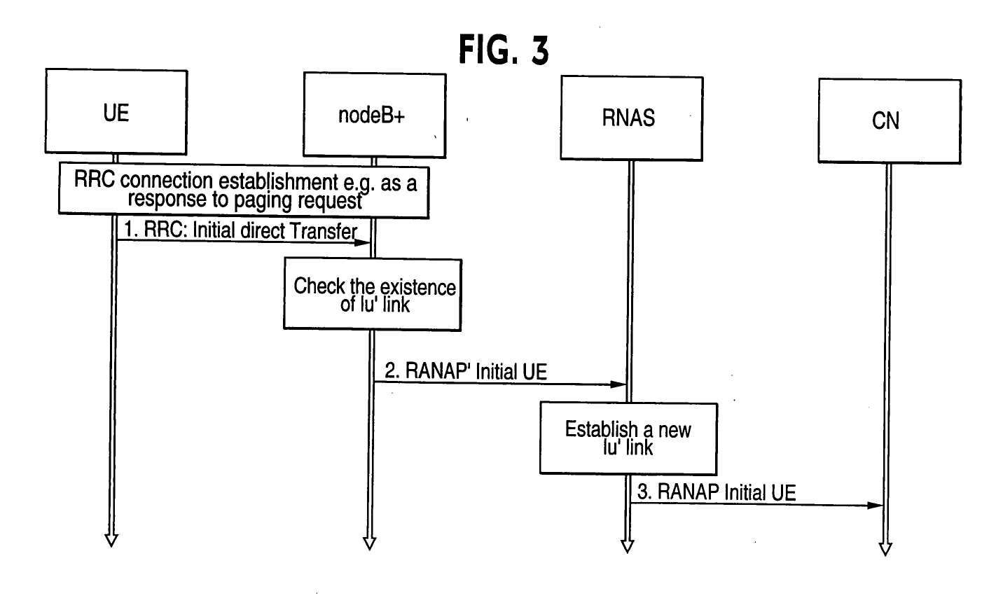

Referring to FIG. 3 we now explain in further detail the establishment of lu′ and lu signaling connections within mobile station's UE initial access. After RRC connection establishment, base station nodeB+ forwards the user's response in RANAP′ Initial UE-message to interworking unit IWU. Currently base station nodeB+ creates a new lu′ signaling link each time when initial access is performed. Although, nodeB+ has to store the association between UE's RRC connection information and both the lu′ signaling connections.

In one embodiment nodeB+ checks for instance on the basis of IMSI/ S-RNTI/G-RNTI/U₁₃ RNTI (SRNC/GERAN/UMTS Radio Network Temporary Identifier), whether there is an existing lu′ signaling link for the user. If such one is found, it is used. Otherwise lu′ signaling link is established and the association between IMSI/S-RNTI/G-RNTI/U_RNTI and lu′ signaling connection identifier is stored. After that nodeB+ sends RANAP′ Initial UE-message to IWU.

When IWU receives a RANAP′ Initial UE-message from nodeB+, it is checks whether the lu′ signaling link is already existing. If it is new, lu′ signaling identifier is saved with mobile station's UE RRC connection information to the database MEM. lu signaling link is established towards the CN in question.

In another embodiment nodeB+ establishes a new lu′ signaling connection and sends RANAP′ Initial UE-message to IWU. When IWU receives a RANAP′ Initial UE-message from nodeB+, the lu′ signaling connection identifier is stored with UE's RRC connection information and a new lu signaling link is established towards the CN in question. IWU saves to its distributed database MEM, containing mobile station's UE IMSI and nodeB+ identifier, the identifiers of the units, which handle mobile station's UE lu signaling links.

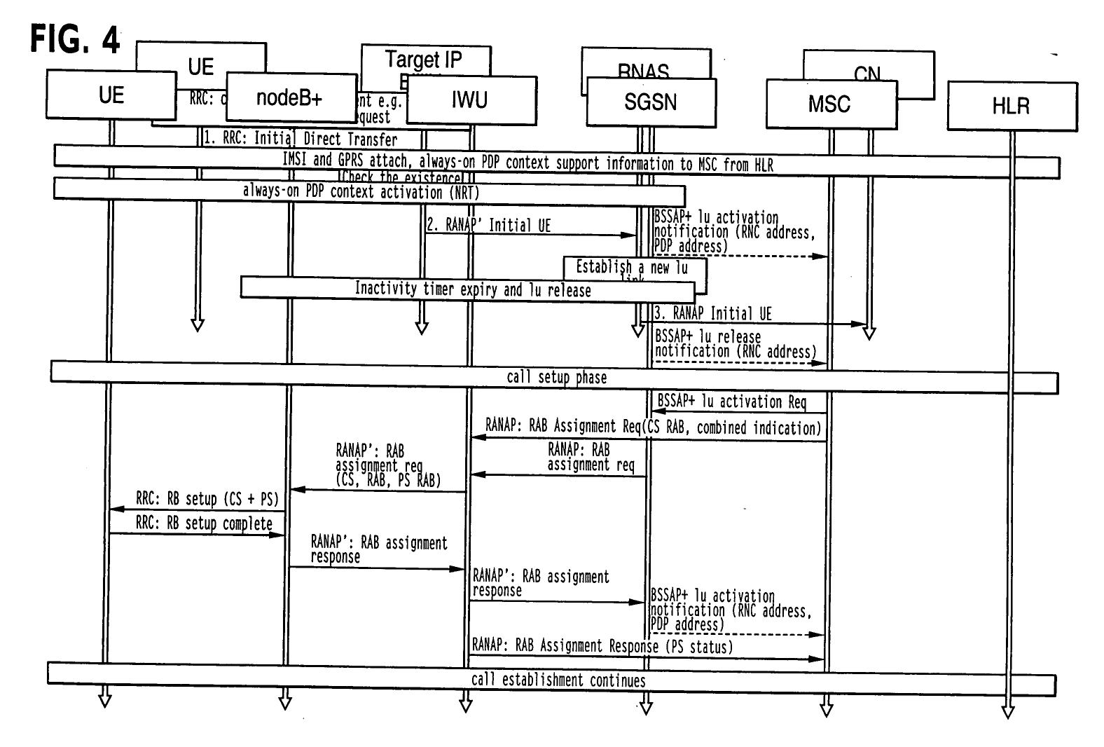

In the following we explain a prefferred embodiment of the present invention referring to FIG. 4. This example relates to a combined set up procedure of Radio Access Bearer (RAB) for both domains, i.e. CS and PS domains.

FIG. 4 discloses an optimized situation in which in connection with normal call (CS domain) set up procedure also a data connection (PS domain) is set up assuming there is not an available one. It is required that user or mobile station UE has “always-on PDP-context” in use and that the information from the context and combined call and data service is stored in Home Location Register (HLR) of user. The mobile switching center (MSC) will be informed about these in connection with IMSI attach—procedure.

Optionally SGSN can inform the situation of lu interface with new messages to MSC. This means that a message will be sent to MSC always when a new lu instance is set up or released. When the call set up progresses to RAB (Radio Access Bearer) set up phase, MSC requests to set up a new lu instance for always-on context from SGSN. SGSN can response to this by OK or establishment started message depending on whether the lu instance is already set up or not. SGSN sends RAB establishment message to radio access network and radio access network sets up a signalling link based on this message. Even if the mobile station does not start sending data immediately, it should be informed that the data connection can be used without setting up a new lu instance.

Information about the release of the lu instance proceeds normally to the mobile station UE. In addition to this the mobile station has to be aware of that combined PS domain and CS domain service is in its use. Thus it is aware of that when CS call is coming the signaling resources are activated also for PS domain. If the set up of combined signalling links fails it has to be notified to mobile station UE.

RANAP RAB set up message has to include an indication if there will be another set up message from another core network domain (CS or PS). Thus interworking unit IWU waits for the other message before it continues with the set up of lu′ instance. RAB set up messages are common for bot domains (CS and PS). In the acknowledgement message of RAB set up is information whether RAB set up procedure succeeded or not.

It is obvious to a person skilled in the art that with the advancement of technology, the basic idea of the invention may be implemented in various ways. The invention and its embodiments are thus not limited to the examples described above, instead they may vary within the scope of the claims.

What is claimed is:

1. A method for implementing a control plane signalling in a radio access network connected to at least two Core Network domains, said method comprising the steps of:
creating a first interface instance (lu-CS, lu-PS) including at least one signalling link for said control plane signalling between an interworking unit (IWU) and a core network (CN) related to one mobile station (UE);
creating a common interface instance (lu′) including one signalling link between said interworking unit and a base station (nodeB+) for control plane signalling; and
directing all control plane signalling related to different Core Network domains via said common interface instance (lu′).

2. Method according to claim 1, further comprising the step of:
creating a common interface instance (lu′) in connection with an initial access of a mobile station (UE).

3. Method according to claim 2, further comprising the step of:
releasing said common interface instance (lu′) when there is no radio access bearer (RAB) and activity for said mobile station (UE).

4. Method according to claim 1, further comprising the step of:
performing a relocation procedure of a mobile station (UE) using said common interface instance (lu′).

5. Method according to claim 4, wherein said relocation procedure is performed with combined signalling messages.

6. Method according to claim 5, wherein said combined signalling messages include at least a CN domain indicator associated to each RAB id in RAB lists.

7. Method according to claim 1, further comprising the step of:
adding a CN domain indicator to a connection oriented message.

8. Method according to claim 5, further comprising the step of:
associating said CN domain indicator in said base station (nodeB+).

9. Method according to claim 1, further comprising the step of:
checking if there is an existing common interface instance (lu′) for UE and using an available instance.

10. Method according to claim 6, further comprising the step of:
storing said CN domain indicator in said interworking unit (IWU).

11. Method according to claim 1, wherein signalling protocol in radio access network is RANAP (Radio Access Network Application Part).

12. A system for implementing a control plane signalling instance in a radio access network connected to at least two Core Network domains, said system comprising:
a base station (nodeB+);
a core network (CN);
an interworking unit (IWU) for connecting said core network (CN) to said base station (nodeB+),
wherein said interworking unit comprises:
a first interface instance (lu-CS, lu-PS) comprising at least one
signalling link for said control plane signalling between said interworking unit (IWU) and said core network (CN) related to one mobile station (UE); a common interface instance (lu′) including one signalling link between said interworking unit (IWU) and said base station (nodeB+) for control plane signalling,
wherein all control plane signalling related to different Core Network domains is directed via said common interface instance (lu′).

13. System according to claim 12, wherein said interworking unit (IWU) is implemented in a radio access network server (RNAS).

14. System according to claim 12, wherein said interworking unit further comprises:
an interface (IWU-lu′) for a common interface instance (lu′).

15. System according to claim 14, wherein said common interface instance (lu′) is released when there is no radio access bearer (RAB) and activity for said mobile station (UE).

16. System according to claim 12, wherein said interworking unit further comprises:
a memory (MEM) for storing a CN domain indicator in said interworking unit (IWU).

17. An interworking unit for implementing a control plane signalling instance in a radio access network connected to at least two Core Network domains, wherein said interworking unit connects a core network (CN) to a base station (nodeB+), said interworking unit further comprising:
a first interface instance (lu-CS, lu-PS) including at least one signalling link for said control plane signalling between an interworking unit and said core network (CN) related to one mobile station (UE);
a common interface instance (lu′) including one signalling link between said interworking unit and said base station (nodeB+) for control plane signalling,
wherein all control plane signalling related to different Core Network domains is directed via said common interface instance (lu′).

18. Interworking unit according to claim 17, wherein said interworking unit is implemented in a radio access network server (RNAS).

19. Interworking unit according to claim 17, further comprising:
an interface (IWU-lu′) for a common interface instance (lu′).

20. Interworking unit according to claim 19, wherein said common interface instance (lu′) is released when there is no radio access bearer (RAB) and activity for said mobile station (UE).

21. Interworking unit according to claim 17, further comprising:
a memory (MEM) for storing a CN domain indicator.
